(19) United States
(12) Patent Application Publication
(10) Pub. No.: US 2026/0224335 A1
(43) Pub. Date: Aug. 6, 2026

(54) DENTAL SURGERY METHOD FOR SINGLE-STAGE DENTAL IMPLANT REPLACEMENT

(71) Applicant: Shih-Cheng WEN, New Taipei City (TW)

(72) Inventors: Hom-Lay WANG, Hsinchu City (TW); Shih-Cheng WEN, New Taipei City (TW)

(21) Appl. No.: 19/046,564

(22) Filed: Feb. 6, 2025

(51) Int. Cl. A61C 8/00

(52) U.S. Cl. CPC A61C 8/0068; A61C 8/0059; A61C 8/0089

(57) ABSTRACT

A dental surgery method for single-stage dental implant replacement, involving removing an abnormal dental implant from a dental alveolus in an oral cavity of a patient, and subsequently implanting a normal dental implant into an alveolar bone through the dental alveolus, the method including the steps of: mounting an implant screw-out component from an implant replacement kit onto a dental handpiece; operating the dental handpiece to drive the implant screw-out component to rotate, so that the abnormal dental implant is loosened from the alveolar bone and removed from the dental alveolus; mounting an implant screw-in component from the implant replacement kit onto the dental handpiece; and operating the dental handpiece to drive the implant screw-in component to rotate to interferentially implant and fix the normal dental implant through the dental alveolus into the alveolar bone. There is an interference-fit relationship between the normal dental implant and the dental alveolus.

### BACKGROUND OF THE INVENTION

### Field of the Invention

The present invention relates to a dental surgery method and, more particularly, to a dental surgery method for single-stage dental implant replacement.

### Description of the Related Art

Please refer to FIG. 1, which shows a cross-sectional view of an original dental implant implanted in an alveolar bone in the prior art. As shown in FIG. 1, under normal circumstances, an original dental implant PA100 is implanted and fixed in an alveolar bone PA200, to allow an abutment tooth PA300 to be installed and fixed by a fixation screw PA400. This allows an artificial dental crown PA500 to be mounted on the top of the abutment tooth PA300.

There is an effective contact depth ECD0 between the original dental implant PA100 and the alveolar bone PA200, and a gingiva PA600 is tightly fitted to the bottom of the artificial dental crown PA500. The effective contact depth ECD0 refers to the depth of contact between the sidewall of the original dental implant PA100 and the alveolar bone PA200, calculated from the contact position to the bottom of the original dental implant PA100. The deeper the effective contact depth ECD0, the larger the contact area between the original dental implant PA100 and the alveolar bone PA200, resulting in better stability.

Under normal circumstances, the implant is semi-permanent, meaning that, with regular checkups and proper care, it can be maintained for a long time without needing to be removed. However, some patients may develop peri-implantitis after dental implantation, with symptoms similar to periodontal disease.

Referring to FIG. 2, a cross-sectional view of alveolar bone loss and gingival recession is illustrated according to the prior art. As shown in FIG. 2, after the onset of peri-implantitis, the gingiva PA600 recedes due to inflammation, and the alveolar bone PA200 experiences dental bone loss as a result of inflammation, causing both biological and structural adverse effects.

Regarding the biological adverse effects, after the gingiva PA600 recedes and the alveolar bone PA200 undergoes bone loss, an abnormal gap PAAG forms between the original dental implant PA100, the alveolar bone PA200, the artificial dental crown PA500, and the gingiva PA600. When micro-organisms from the patient's oral cavity fall into the abnormal gap PAAG, they attach to the surface of the original dental implant PA100 to form a microbial biofilm PA700. Once the thickness or accumulation of the microbial biofilm PA700 reaches a certain level, making it impossible to be removed through cleaning or scraping, the original dental implant PA100 needs to be extracted.

Concerning the structural adverse effects, the loss of the alveolar bone PA200 reduces the effective contact depth between the original dental implant PA100 and the alveolar bone PA200 from the original effective contact depth ECD0 to an effective contact depth ECD1, resulting in a reduction in the contact area between the original dental implant PA100 and the alveolar bone PA200, leading to the loosening of the original dental implant PA100 and the risk of its detachment, thus requiring the removal of the original dental implant PA100.

Furthermore, even without the recession of the gingiva PA600 or the loss of the alveolar bone PA200, the original dental implant PA100 also needs to be removed if it sustains damage (such as fractures) due to external forces (such as accidental impacts or forces from biting on hard objects). Regardless of which reason above, the original dental implant PA100 can be considered as an abnormal dental implant when a dentist determines that the original dental implant PA100 needs to be removed.

In the prior art, the removal of the original dental implant PA100 typically involves first removing the artificial dental crown PA500, the fixation screw PA400, and the abutment tooth PA300 in sequence. Then, an implant screw-out component PA801 (as shown in FIG. 3) mounted on a dental handpiece PA800 (i.e., a handheld dental surgery machine for dental professionals, as shown in FIG. 3) is engaged with an engagement groove PADG of the original dental implant PA100 (as shown in FIG. 3). Finally, the dental handpiece PA800 is operated to drive the implant screw-out component PA801 to rotate, so that the original dental implant PA100 is loosened from the alveolar bone PA200 and removed (alternatively, a dental torque wrench can be used to drive the implant screw-out component PA801 to rotate to loosen and remove the original dental implant PA100 from the alveolar bone PA200).

However, since the original dental implants PA100 from different manufacturers vary in profile shapes (such as hexagonal, star-shaped, flat-headed, or cross-shaped) and in the dimensions of their engagement grooves PADG. During dental surgery, a dentist may not always have an implant screw-out component PA801 that exactly matches the shape and size of the engagement groove PADG.

Please refer to FIG. 3, which shows a cross-sectional view where the size of the implant screw-out component does not match the engagement groove. Due to the inconsistent profile shapes and dimensions of the engagement grooves PADG of original dental implants PA100 across manufacturers, when the dimension of the implant screw-out component PA801 is smaller than the inner diameter of the engagement groove PADG (as shown in FIG. 3), it will result in the inability to tightly engage the implant screw-out component PA801 with the engagement groove PADG, thus preventing the removal of the original dental implant PA100.

Referring to FIG. 4, a cross-sectional view of creating an implant removal slot in the alveolar bone in the prior art is shown. In the prior art, if the original dental implant PA100 cannot be removed using the implant screw-out component PA801, the dentist typically uses the bone trephine PA802 to cut an implant removal slot PATG on the alveolar bone PA200 surrounding the original dental implant PA100 after mounting the bone trephine PA802 onto the dental handpiece PA800, thereby removing the original dental implant PA100 along with bone fragments generated during cutting through the implant removal slot PATG.

Please refer to FIG. 5 and FIG. 6, where FIG. 5 shows a cross-sectional view of filling the implant removal slot with a bone graft material in the prior art, while FIG. 6 shows a cross-sectional view of bone graft material hardening through osseointegration in the prior art. After cutting an implant removal slot PATG in the alveolar bone PA200 around the original dental implant PA100, the inner diameter of the implant removal slot PATG is necessarily larger than the outer diameter of the original dental implant PA100 to avoid direct contact between the bone trephine PA802 and the hard original dental implant PA100, making it impossible to directly implant and fix a new normal dental implant PA101 (as shown in FIG. 7) into the alveolar bone PA200 during this surgery.

Meanwhile, as shown in FIG. 5, the bone graft material PA900 must be filled into the implant removal slot PATG. After a bone integration process of three to six months with the bone graft material PA900, it is necessary for a dentist to examine and evaluate whether the bone graft material PA900 has sufficiently hardened and successfully integrated with the alveolar bone PA200. If the dentist's examination and evaluation reveal unsatisfactory hardening or osseointegration of the bone graft material, further waiting or corrective surgery may be required, followed by subsequent examinations and evaluations.

Please refer to FIG. 7 and FIG. 8, where FIG. 7 shows a cross-sectional view of creating a new implant insertion slot after osseointegration in the prior art, while FIG. 8 shows a cross-sectional view of implanting and fixing a normal dental implant through the implant insertion slot into the alveolar bone in the prior art. As shown in FIG. 7 and FIG. 8, only after the dentist examines and confirms good hardening and osseointegration (as shown in FIG. 6) can an implant insertion slot PAIG be created in the alveolar bone PA200. Subsequently, after implanting and fixing the normal dental implant PA101 through the implant insertion slot PAIG into the alveolar bone PA200, a healing abutment PA501 is installed and an osseointegration process is awaited to complete a dental surgery for implant replacement.

From the above description, it is known that in the prior art, after removing the original dental implant PA100, it takes three to six months to wait for the bone graft material PA900 to complete osseointegration with the alveolar bone PA200, and only after the dentist examines and confirms satisfactory hardening and osseointegration of the bone graft material can an implant insertion slot PAIG be created for the subsequent implant surgery. Obviously, in the prior art, it often necessitates two or three surgeries over three to six months (or even longer) to successfully complete implant replacement. This not only causes patients to endure multiple painful surgeries but also results in extended surgical waiting periods and higher consumption of surgical resources.

### BRIEF SUMMARY OF THE INVENTION

Given that in the prior art, it is generally impossible to complete implant replacement in a single dental surgery, causing patients to endure repeated psychological trauma from pain across multiple surgeries, long waiting periods between surgeries, and significant consumption of surgical resources. One object of the present invention is to provide a dental surgery method for single-stage dental implant replacement, which involves removing an abnormal dental implant from a dental alveolus while causing minimal damage to an alveolar bone, allowing a normal dental implant having an interference-fit relationship with the dental alveolus to be implanted and fixed into the alveolar bone through the dental alveolus in the same dental surgery, thereby solving the aforementioned issues.

Accordingly, the necessary technical means adopted by the present invention to solve the problems of the prior art is to provide a dental surgery method for single-stage dental implant replacement, involving removing an abnormal dental implant from a dental alveolus in an oral cavity of a patient and subsequently implanting a normal dental implant into an alveolar bone through the dental alveolus.

In this dental surgery method, first, an implant screw-out component from an implant replacement kit is first mounted onto a dental handpiece. Then, the dental handpiece is operated to drive the implant screw-out component to rotate, so that the abnormal dental implant is loosened from the alveolar bone and removed from the dental alveolus.

Next, an implant screw-in component from the implant replacement kit is mounted onto the dental handpiece. The dental handpiece is then operated to drive the implant screw-in component to rotate so as to interferentially implant and fix the normal dental implant through the dental alveolus into the alveolar bone, so that the normal dental implant fully occupies the dental alveolus and is fixed in the dental alveolus. There is an interference-fit relationship between the normal dental implant and the dental alveolus.

Based on the above necessary technical means, the following auxiliary technical means can be derived. Preferably, the normal dental implant has an outer diameter larger than that of the abnormal dental implant by 0.2~1.5 mm, thereby establishing the interference-fit relationship between the normal dental implant and the dental alveolus.

Based on the above necessary technical means, the following auxiliary technical means can be derived. Preferably, the normal dental implant has a length larger than that of the abnormal dental implant by 2~4 mm, thereby establishing the interference-fit relationship between the normal dental implant and the dental alveolus.

If the abnormal dental implant includes an original engagement groove, the implant screw-out component mounted on the dental handpiece can be engaged with the original engagement groove (or using an implant screw-out component mounted on a dental torque wrench). The implant screw-out component used at this point may include a screw-out component mounting section and a screw-out section. The screw-out component mounting section is configured to be mounted and fixed onto the dental handpiece. The screw-out section extends from the screw-out component mounting section and has engagement threads formed on a surface thereof to interferentially engage with the original engagement groove when the implant screw-out component is driven to rotate, thereby directly rotating and removing the abnormal dental implant from the dental alveolus.

Conversely, if the abnormal dental implant does not include an original engagement groove, or if the original engagement groove is damaged and cannot be directly removed by rotating with the implant screw-out component, an implant cutting component from the implant replacement kit can be mounted onto the dental handpiece, and the dental handpiece can be operated to drive the implant cutting component to rotate so as to cut a post-manufactured engagement groove on a top surface of the abnormal dental implant.

After cutting the post-manufactured engagement groove, the implant screw-out component from the implant replacement kit is mounted onto the dental handpiece and engaged with the post-manufactured engagement groove, allowing the abnormal dental implant to be rotated and removed from the dental alveolus. The implant screw-out component used at this point can include a screw-out component mounting section and a screw-out section. The screw-out component mounting section is configured to be mounted and fixed onto the dental handpiece. The screw-out section extends from the screw-out component mounting section. The screw-out section has an outer peripheral shape matching an inner peripheral shape of the post-manufactured engagement groove to engage with the post-manufactured engagement groove.

To facilitate cutting, preferably, the implant cutting component can include a cutting component mounting section and a cutting section. The cutting component mounting section is configured to be mounted and fixed onto the dental handpiece. The cutting section extends from the cutting component mounting section for cutting the post-manufactured engagement groove.

When implanting and fixing the normal dental implant through the dental alveolus into the alveolar bone, preferably, the normal dental implant can include an implant engagement groove, which can be a polygonal implant engagement groove. The implant screw-in component used at this point includes a screw-in component mounting section and a screw-in section. The screw-in component mounting section is configured to be mounted and fixed onto the dental handpiece. The screw-in section extends from the screw-in component mounting section. The screw-in section has an outer peripheral shape matching an inner peripheral shape of the implant engagement groove to engage with the implant engagement groove.

In summary, the dental surgery method for single-stage dental implant replacement provided by the present invention achieves smooth removal of the abnormal dental implant from the dental alveolus by directly using an original engagement groove or cutting a post-manufactured engagement groove, with minimal damage to the alveolar bone around the dental alveolus. This allows a normal dental implant having an interference-fit relationship with the dental alveolus to be re-implanted and fixed into the alveolar bone through the dental alveolus in the same dental surgery, resulting in the effects of reducing patients'suffering, shortening surgery time, and reducing surgical resource consumption.

The specific embodiments of the present invention will be further described and illustrated with the following embodiments and figures.

### BRIEF DESCRIPTION OF THE DRAWINGS

FIG. 1 shows a cross-sectional view of an original dental implant implanted in an alveolar bone in the prior art;

FIG. 2 shows a cross-sectional view of alveolar bone loss and gingival recession in the prior art;

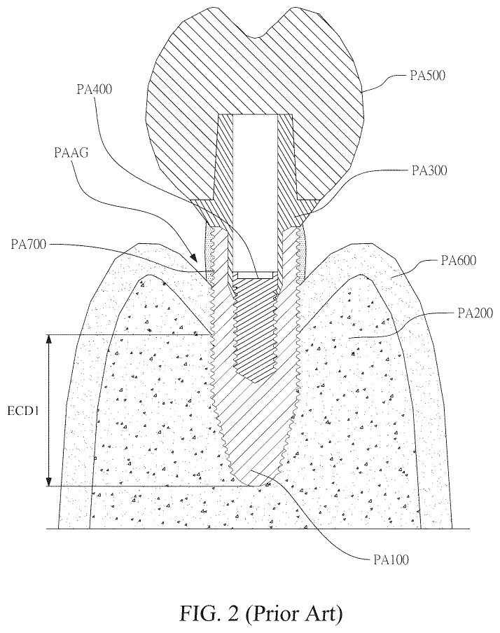

FIG. 3 shows a cross-sectional view where the size of the implant screw-out component does not match the engagement groove;

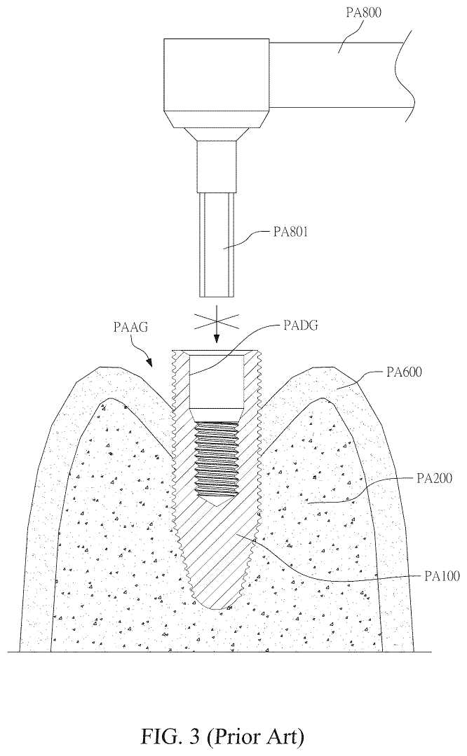

FIG. 4 shows a cross-sectional view of creating an implant removal slot in the alveolar bone in the prior art;

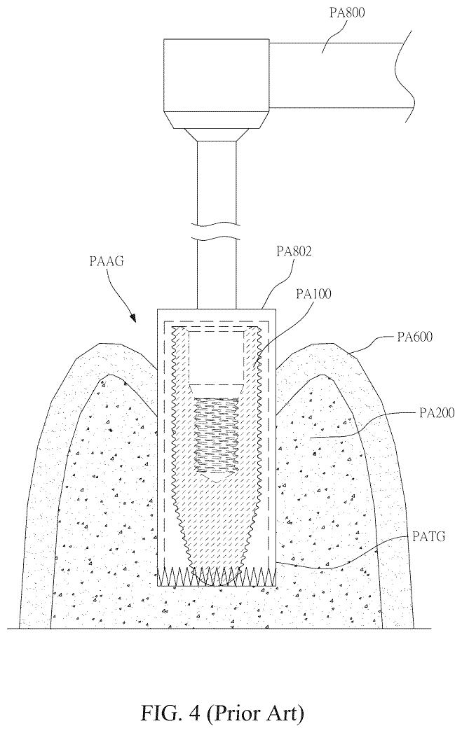

FIG. 5 shows a cross-sectional view of filling the implant removal slot with a bone graft material in the prior art;

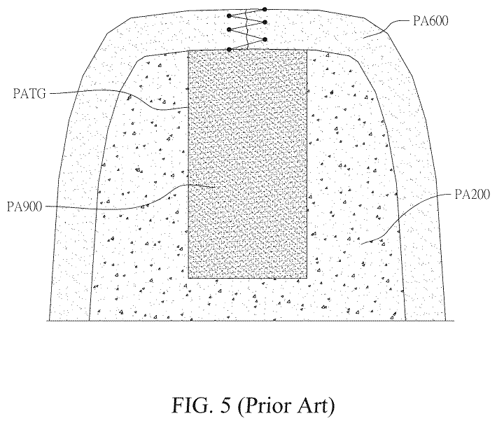

FIG. 6 shows a cross-sectional view of bone graft material hardening through osseointegration in the prior art;

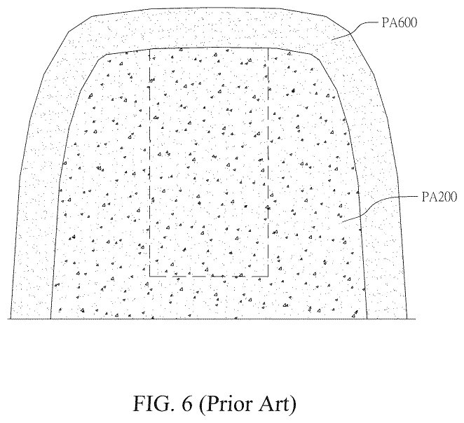

FIG. 7 shows a cross-sectional view of re-creating an implant insertion slot after osseointegration in the prior art;

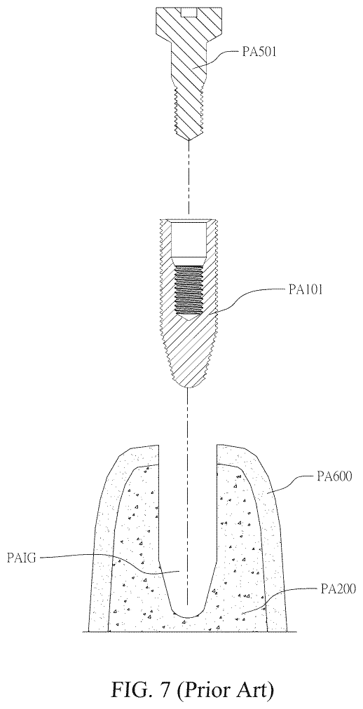

FIG. 8 shows a cross-sectional view of implanting and fixing a normal dental implant through the implant insertion slot into the alveolar bone in the prior art

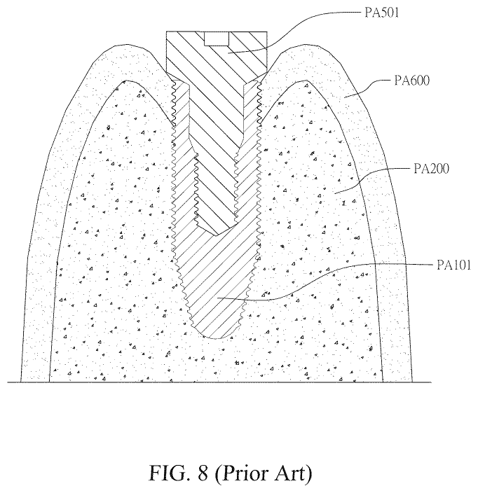

FIG. 9 shows perspective views of implant replacement kits and normal dental implants for various abnormal dental implants in a dental surgery method for single-stage dental implant replacement according to the present invention;

FIG. 10 shows perspective views of mounting an implant screw-out component from an implant replacement kit onto a dental handpiece or a dental torque wrench in a dental surgery method for single-stage dental implant replacement according to the present invention;

FIG. 11 shows a cross-sectional view of an abnormal dental implant implanted and fixed in an alveolar bone in a dental surgery method for single-stage dental implant replacement according to a first embodiment of the present invention;

FIG. 12 is a flowchart of a dental surgery method for single-stage dental implant replacement according to a first embodiment of the present invention;

FIG. 13 shows a cross-sectional view of an implant screw-out component engaging with an original engagement groove of an abnormal dental implant in a dental surgery method for single-stage dental implant replacement according to a first embodiment of the present invention;

FIG. 14 shows a cross-sectional view of a dental alveolus after removing an abnormal dental implant in a dental surgery method for single-stage dental implant replacement according to a first embodiment of the present invention;

FIG. 15 shows a cross-sectional view of an implant screw-in component engaging with an implant engagement groove in a dental surgery method for single-stage dental implant replacement according to a first embodiment of the present invention;

FIG. 16 shows a cross-sectional view after a normal dental implant is implanted and fixed in an alveolar bone in a dental surgery method for single-stage dental implant replacement according to a first embodiment of the present invention;

FIG. 17 shows a cross-sectional view of an abnormal dental implant implanted and fixed in an alveolar bone in a dental surgery method for single-stage dental implant replacement according to a second embodiment of the present invention;

FIG. 18 is a flowchart of a dental surgery method for single-stage dental implant replacement according to a first embodiment of the present invention;

FIG. 19 shows a cross-sectional view of an implant cutting component cutting a post-manufactured engagement groove on a top surface of an abnormal dental implant in a dental surgery method for single-stage dental implant replacement according to a second embodiment of the present invention; and

FIG. 20 shows a cross-sectional view of an implant screw-out component engaging with a post-manufactured engagement groove of an abnormal dental implant in a dental surgery method for single-stage dental implant replacement according to a second embodiment of the present invention.

### DETAILED DESCRIPTION OF THE EMBODIMENTS

Since the dental surgery method for single-stage dental implant replacement provided by the present invention can be widely applied to various dental surgery scenarios, detailed descriptions of all possible applications will not be provided here. Instead, two preferred embodiments are presented to specifically illustrate the methods of removing two types of abnormal dental implants. These two embodiments serve merely to conveniently and clearly explain the purpose and effects of the present invention embodiments.

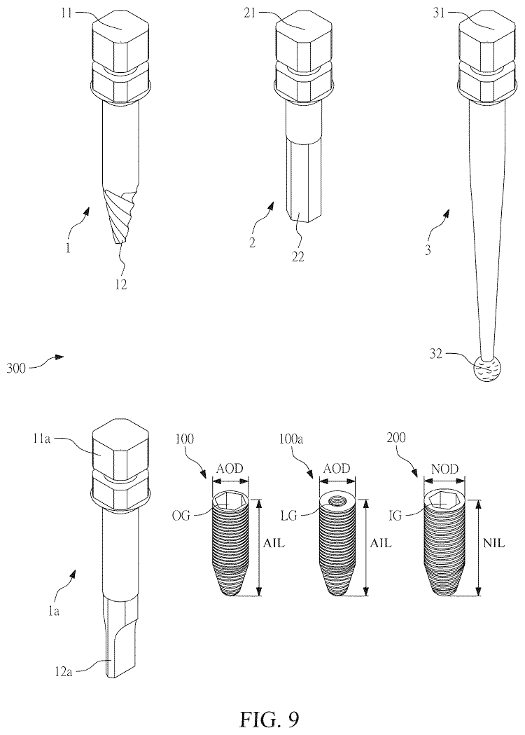

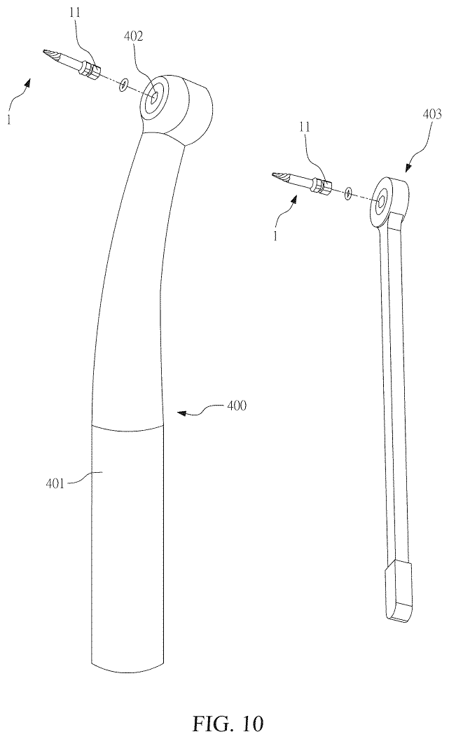

Please refer to FIG. 9 and FIG. 10, where FIG. 9 shows perspective views of implant replacement kits and normal dental implants for various abnormal dental implants in a dental surgery method for single-stage dental implant replacement according to the present invention, while FIG. 10 shows perspective views of mounting an implant screw-out component from an implant replacement kit onto a dental handpiece or a dental torque wrench in a dental surgery method for single-stage dental implant replacement according to the present invention.

As shown in FIG. 9 and FIG. 10, the present invention uses a dental handpiece 400 together with an implant replacement kit 300 to replace two different abnormal dental implants 100 or 100a with a normal dental implant 200. The abnormal dental implant 100 has an outer diameter AOD, a length AIL, and an original engagement groove OG at its top. The abnormal dental implant 100a has an outer diameter AOD, a length AIL, and a latch groove LG, where the inner peripheral shape of the latch groove LG is circular. The normal dental implant 200 has an outer diameter NOD, a length NIL, and an implant engagement groove IG. The implant engagement groove IG is created at the top of the normal dental implant 200.

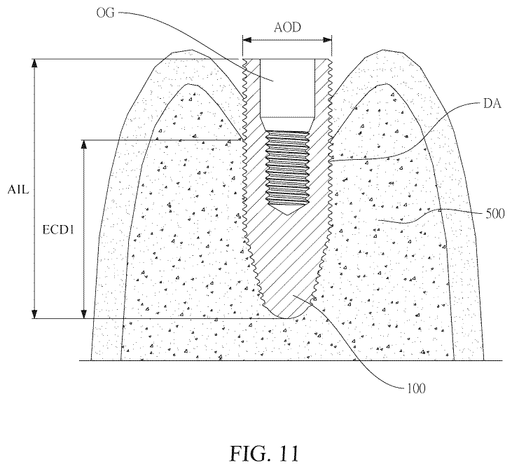

In dental surgery, the engagement grooves (including the original engagement grooves OG and the implant engagement groove IG) are engaged by locking tools (such as a hexagonal wrench matching a hexagonal engagement groove) that matches the shape and size of the engagement groove. When the locking tool rotates, it either locks the implants (including the abnormal dental implant 100 and the normal dental implant 200) into a dental alveolus DA in an alveolar bone 500 (shown in FIG. 11) or detaches them from the alveolar bone 500.

In the present invention, the inner peripheral shapes of both the original engagement groove OG and the implant engagement groove IG are hexagonal. In other embodiments, the inner peripheral shapes of the original engagement groove OG and the implant engagement groove IG may be different polygons, such as star-shaped, straight-lined (elongated rectangle), or cross-shaped.

The implant replacement kit 300 includes two implant screw-out components 1 and 1a, an implant screw-in component 2, and an implant cutting component 3. The implant screw-out component 1 includes a screw-out component mounting section 11 and a screw-out section 12. The screw-out component mounting section 11 is configured to be mounted and fixed onto a dental handpiece 400 or a dental torque wrench 403. The screw-out section 12 extends from the screw-out component mounting section 11 and has engagement threads formed on a surface thereof.

The implant screw-out component 1a includes a screw-out component mounting section 11a and a screw-out section 12a. The screw-out component mounting section 11a is configured to be mounted and fixed onto a dental handpiece 400 or a dental torque wrench 403. The screw-out section 12a extends from the screw-out component mounting section 11a.

The implant screw-in component 2 includes a screw-in component mounting section 21 and a screw-in section 22. The screw-in component mounting section 21 is configured to be mounted and fixed onto a dental handpiece 400 or a dental torque wrench 403. The screw-in section 22 extends from the screw-in component mounting section 21, and the screw-in section 22 has an outer peripheral shape matching an inner peripheral shape of the implant engagement groove IG to engage with the implant engagement groove IG. In this embodiment, the outer peripheral shape of the screw-in section 22 is hexagonal.

The implant cutting component 3 includes a cutting component mounting section 31 and a cutting section 32. The cutting component mounting section 31 is configured to be mounted and fixed onto a dental handpiece 400. The cutting section 32 extends from the cutting component mounting section 31. In the present invention, the cutting section 32 has a ball-nose end and a hardened protruding structure on its surface. More specifically, in the present invention, the implant screw-out components 1 and 1a, the implant screw-in component 2, and the implant cutting component 3 are all made of tungsten steel or other materials with hardness equal to or greater than tungsten steel, which is much harder than the abnormal dental implants 100 or 100a typically made of titanium alloy.

The dental handpiece 400 includes a handheld section 401 and a mounting drive section 402. The handheld section 401 is configured for the dentist to hold, while the mounting drive section 402 is configured to mount and fix the implant screw-out components 1 or 1a, the implant screw-in component 2, or the implant cutting component 3, providing rotational driving force to drive the implant screw-out components 1 and 1a, the implant screw-in component 2, or the implant cutting component 3 to rotate. The working principles and structures of the dental handpiece 400 are similar or identical to those of the dental handpiece PA800 in the prior art, which will not be elaborated in this embodiment.

The dental torque wrench 403 is configured to mount and fix the implant screw-out component 1 or 1a or the implant screw-in component 2, to provide rotational driving force to drive the implant screw-out component 1 or 1a or the implant screw-in component 2 to rotate. The structures and working principles of the dental torque wrench 403 are based on the prior art, which will not be elaborated in this embodiment.

Please refer to FIG. 11, which shows a cross-sectional view of an abnormal dental implant implanted and fixed in an alveolar bone in a dental surgery method for single-stage dental implant replacement according to a first embodiment of the present invention.

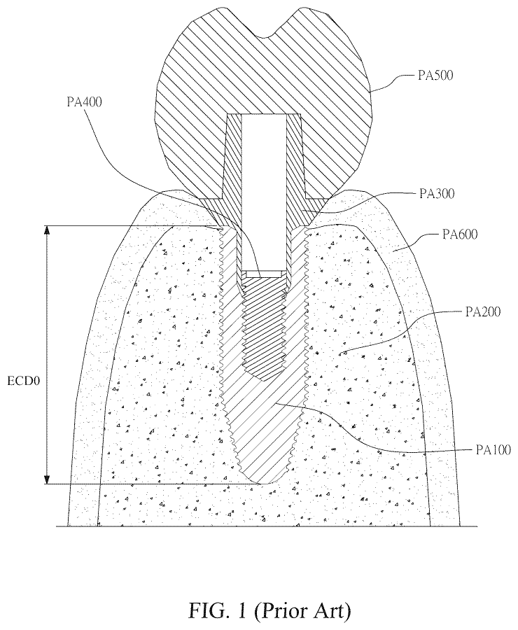

As shown in FIG. 11, the abnormal dental implant 100 is fixed in the alveolar bone 500. At this point, there exists an effective contact depth ECD1 between the abnormal dental implant 100 and alveolar bone 500, which is the same as in the prior art. The effective contact depth ECD1 refers to the depth of contact between the sidewall of the abnormal dental implant 100 and the alveolar bone 500, measured from the contact position to the bottom of the abnormal dental implant 100. In a first embodiment, the effective contact depth ECD1 is smaller than the effective contact depth ECD0 (as shown in FIG. 1). In other words, the abnormal dental implant 100 is more prone to loosening and needs replacement due to the risk of falling out.

Generally, an implant screw-out component that matches the shape and size of the original engagement groove OG can be engaged with the original engagement groove OG, Then, the dental handpiece 400 or the dental torque wrench 403 can be used to drive the implant screw-out component to rotate to detach the abnormal dental implant 100 from the alveolar bone 500. In other embodiments, when the shape and size of the implant engagement groove IG match those of the original engagement groove OG, the implant screw-in component 2 can also serve as an implant screw-out component.

However, since implants manufactured by different companies vary, the contour and dimensions of the original engagement groove OG of the abnormal dental implant 100 also differ. Consequently, the contour and dimensions of the implant screw-out component used by dentists during surgery may not necessarily match the original engagement groove OG of the abnormal dental implant 100.

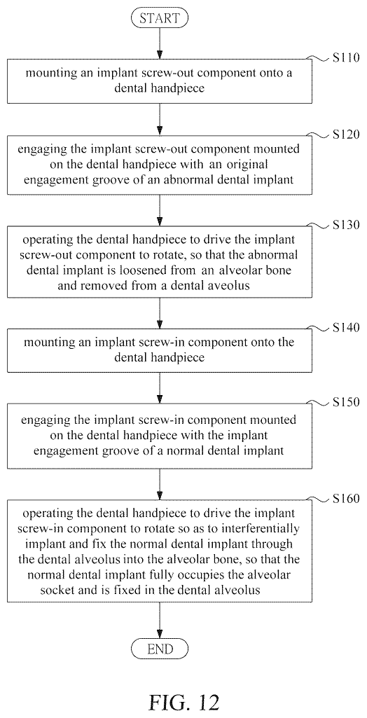

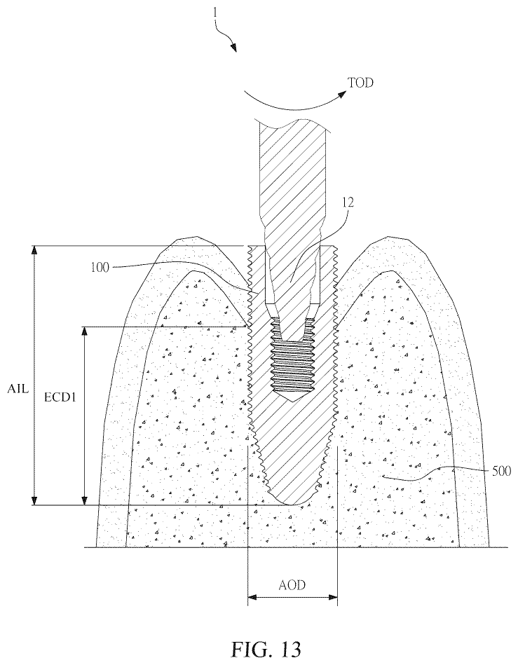

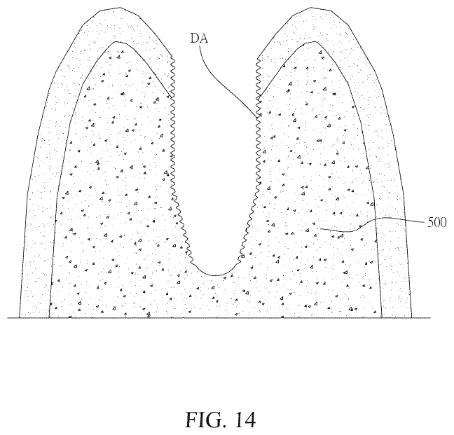

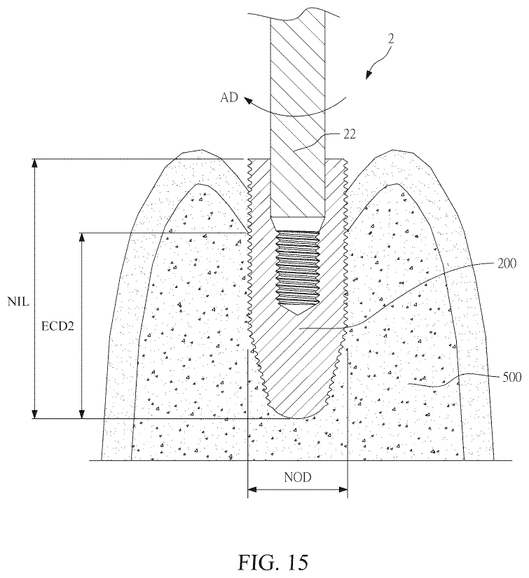

Please refer to FIG. 12 to FIG. 15. FIG. 12 is a flowchart of a dental surgery method for single-stage dental implant replacement according to a first embodiment of the present invention; FIG. 13 shows a cross-sectional view of an implant screw-out component engaging with an original engagement groove of an abnormal dental implant in a dental surgery method for single-stage dental implant replacement according to a first embodiment of the present invention; FIG. 14 shows a cross-sectional view of a dental alveolus after removing an abnormal dental implant in a dental surgery method for single-stage dental implant replacement according to a first embodiment of the present invention; and FIG. 15 shows a cross-sectional view of an implant screw-in component engaging with an implant engagement groove in a dental surgery method for single-stage dental implant replacement according to a first embodiment of the present invention.

As shown in FIG. 12, to remove the abnormal dental implant 100, a dental surgery method for single-stage dental implant replacement according to a first embodiment of the present invention includes Steps S110 to S160. Please refer to Steps S110 to S130 along with FIGS. 13 and 14. First, in Step S110, a screw-out component mounting section 11 of an implant screw-out component 1 from an implant replacement kit 300 is mounted and fixed onto a dental handpiece 400. Then, in Step S120, a screw-out section 12 of the implant screw-out component 1 mounted on the dental handpiece 400 is engaged with an original engagement groove OG of an abnormal dental implant 100.

Next, in Step S130, the dental handpiece 400 is operated to drive the implant screw-out component 1 to rotate along a take-out direction TOD, so that the abnormal dental implant 100 is loosened from an alveolar bone 500 and removed from a dental alveolus DA. At this point, the inner diameter of the dental alveolus DA remains very close to the outer diameter AOD of the abnormal dental implant 100.

In Step S130, since the screw-out section 12 is a conical structure with engagement threads on its surface, when the implant screw-out component 1 is driven to rotate, regardless of the shape of the original engagement groove OG, as long as the screw-out section 12 can be inserted into the original engagement groove OG and can interferentially contact and engage with the original engagement groove OG, the abnormal dental implant 100 can be driven to rotate in tandem, thereby removing the abnormal dental implant 100.

Please refer to Steps S140 to S160, along with FIG. 15. In Step S140, a screw-in component mounting section 21 of an implant screw-in component 2 from the implant replacement kit 300 is mounted onto the dental handpiece 400. Then, in Step S150, the screw-in section 22 of the implant screw-in component 2 mounted on the dental handpiece 400 is engaged with an implant engagement groove IG of a normal dental implant 200.

Finally, in Step S160, the dental handpiece 400 is operated to drive the implant screw-in component 2 to rotate along an assembly direction AD so as to interferentially implant and fix the normal dental implant 200 through the dental alveolus DA into the alveolar bone 500, so that the normal dental implant 200 fully occupies the dental alveolus DA and is fixed in the dental alveolus DA.

To ensure an interference-fit relationship between the normal dental implant 200 and the dental alveolus DA, preferably, the outer diameter NOD of the normal dental implant 200 is larger than the outer diameter AOD of the abnormal dental implant 100. Practically, the outer diameter NOD of the normal dental implant 200 is 0.2~1.5mm larger than the outer diameter AOD of the abnormal dental implant 100 to create a horizontal interference-fit relationship. In this embodiment, the outer diameter NOD of the normal dental implant 200 is larger than the outer diameter AOD of the abnormal dental implant 100.

Furthermore, in other embodiments, the length NIL of the normal dental implant 200 may also be greater than the length AIL of the abnormal dental implant 100. More particularly, a vertical interference-fit relationship can be achieved through threading by the normal dental implant 200 into the alveolar bone 500. In practice, the length NIL of the normal dental implant 200 is 2~4mm greater than the length AIL of the abnormal dental implant 100.

In some embodiments, if the condition of the dental alveolus DA is deemed satisfactory after the dentist removes the abnormal dental implant 100, a normal dental implant 200 of the same size as the abnormal dental implant 100 can also be immediately implanted and fixed into the alveolar bone 500.

Furthermore, after the normal dental implant 200 is implanted and fixed in the alveolar bone 500, there exists an effective contact depth ECD2 between the normal dental implant 200 and the alveolar bone 500, which is inevitably greater than the effective contact depth ECD1 between the abnormal dental implant 100 and the alveolar bone 500. In other words, the contact area between the normal dental implant 200 and the alveolar bone 500 is larger than that between the abnormal dental implant 100 and the alveolar bone 500, resulting in greater stability and reduced wobbling for the normal dental implant 200 compared to the abnormal dental implant 100.

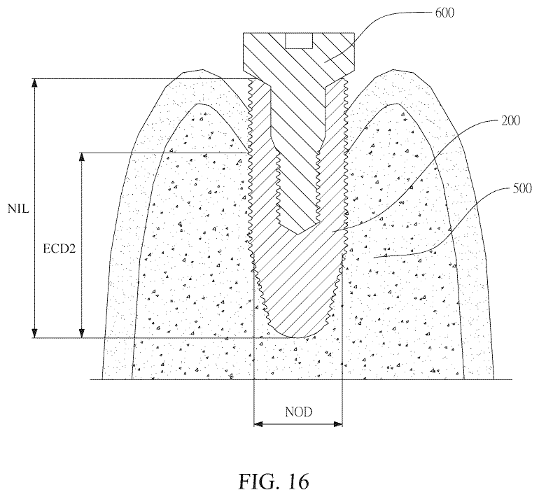

Please refer to FIG. 16, which shows a cross-sectional view after a normal dental implant is implanted and fixed in an alveolar bone in a dental surgery method for single-stage dental implant replacement according to a first embodiment of the present invention. As shown in FIG. 16, after the normal dental implant 200 is implanted and fixed in the alveolar bone 500, a healing abutment 600 is attached and osseointegration is awaited to complete the single-stage dental implant replacement surgery.

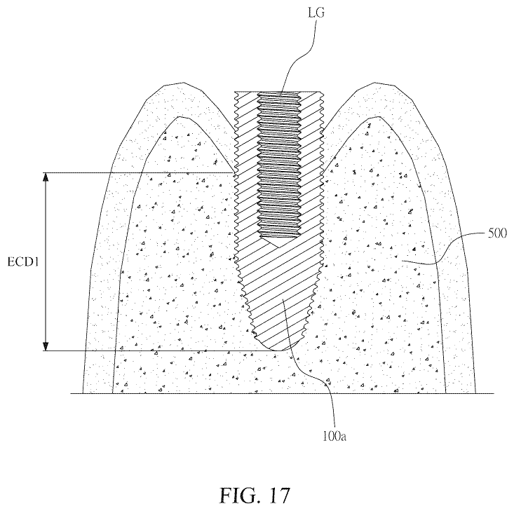

Please refer to FIG. 17, which shows a cross-sectional view of an abnormal dental implant implanted and fixed in an alveolar bone in a dental surgery method for single-stage dental implant replacement according to a second embodiment of the present invention. As shown in FIG. 17, the abnormal dental implant 100a is fixed in the alveolar bone 500. In a second embodiment, the inner peripheral shape of the latch groove LG of the abnormal dental implant 100a is circular, preventing engagement with the implant screw-out components 1 and 1a. Thus, the abnormal dental implant 100a cannot be removed using the implant screw-out components 1 and 1a.

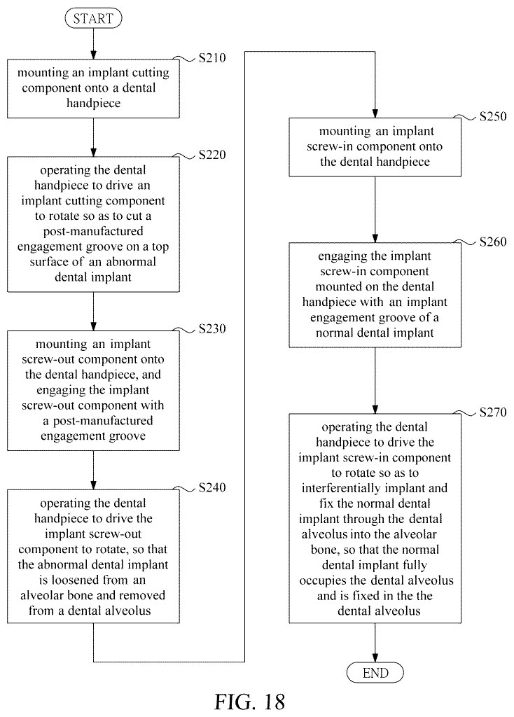

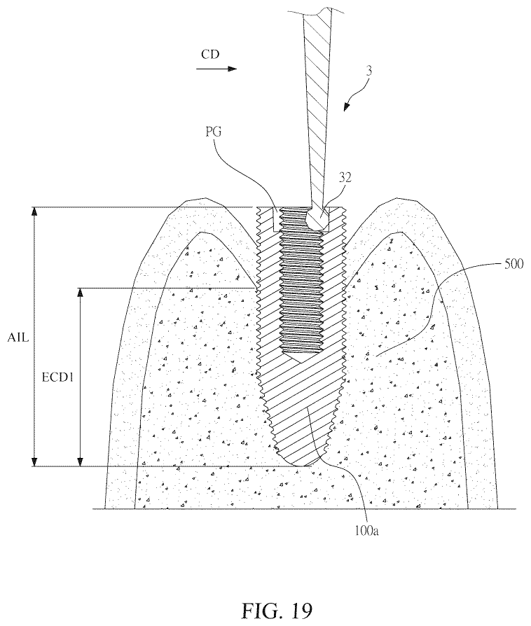

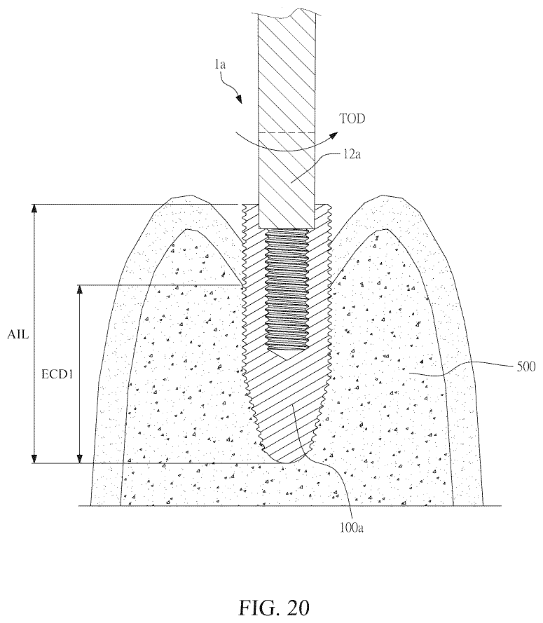

Please refer to FIG. 18 to FIG. 20. FIG. 18 is a flowchart of a dental surgery method for single-stage dental implant replacement according to a first embodiment of the present invention; FIG. 19 shows a cross-sectional view of an implant cutting component cutting a post-manufactured engagement groove on a top surface of an abnormal dental implant in a dental surgery method for single-stage dental implant replacement according to a second embodiment of the present invention; and FIG. 20 shows a cross-sectional view of an implant screw-out component engaging with a post-manufactured engagement groove of an abnormal dental implant in a dental surgery method for single-stage dental implant replacement according to a second embodiment of the present invention.

As shown in FIG. 18, a dental surgery method for single-stage dental implant replacement according to a second embodiment of the present invention includes Steps S210 to S270. Please refer to Steps S210 to S220 along with FIG. 19. First, in Step S210, a cutting component mounting section 31 of an implant cutting component 3 from an implant replacement kit 300 is mounted and fixed onto a dental handpiece 400. Then, in Step S220, the dental handpiece 400 is operated to drive the implant cutting component 3 to rotate at a high speed and move along a cutting direction CD at the top of an abnormal dental implant 100a, enabling the cutting section 32 to cut a post-manufactured engagement groove PG at the top of the abnormal dental implant 100a.

Due to the hardened protruding structures on the surface at one end of the cutting section 32 and the fact that the hardness of the implant cutting component 3 exceeds that of the abnormal dental implant 100a, the implant cutting component 3, when rotating at a high speed, can cut the post-manufactured engagement groove PG on the top of the abnormal dental implant 100a through friction force.

Please refer to Steps S230 to S240, along with FIG. 20. In Step S230, a screw-out component mounting section 11a of an implant screw-out component 1a from the implant replacement kit 300 is mounted and fixed onto the dental handpiece 400, and engages with the post-manufactured engagement groove PG using a screw-out section 12a. The dashed line in FIG. 20 represents the upper boundary of the screw-out section 12a. Then, in Step S240, the dental handpiece 400 is operated to drive the implant screw-out component 1a to rotate along the take-out direction TOD, so that the abnormal dental implant 100a is loosened from the alveolar bone 500 and removed from the alveolar bone 500 and removed from the dental alveolus DA.

In steps S210 to S240, the screw-out section 12a has an outer peripheral shape matching an inner peripheral shape of the post-manufactured engagement groove PG to engage with the post-manufactured engagement groove PG. In this embodiment, the screw-out section 12a has a flat end, and the inner peripheral shape of the post-manufactured engagement groove PG is rectangular to match the flat end.

Since Steps S250 to S270 are similar to Steps S140 to S160 in the first embodiment, please refer to FIG. 14 to FIG. 16 for the corresponding illustrations.

In Step S250, a screw-in component mounting section 21 of an implant screw-in component 2 from the implant replacement kit 300 is mounted onto the dental handpiece 400. Then, in Step S260, the screw-in section 22 of the implant screw-in component 2 mounted on the dental handpiece 400 is engaged with the implant engagement groove IG of a normal dental implant 200. Finally, in Step S270, the dental handpiece 400 is operated to drive the implant screw-in component 2 to rotate along the assembly direction AD so as to interferentially implant and fix the normal dental implant 200 through the dental alveolus DA into the alveolar bone 500, so that the normal dental implant 200 fully occupies the dental alveolus DA and is fixed in the dental alveolus DA.

After the normal dental implant 200 is implanted and fixed in the alveolar bone 500, there exists an effective contact depth ECD2, which is greater than the effective contact depth ECD1. This means that the contact area between the normal dental implant 200 and the alveolar bone 500 is larger than that between the abnormal dental implant 100a and the alveolar bone 500, resulting in greater stability and reduced wobbling for the normal dental implant 200 compared to the abnormal dental implant 100a.

Finally, after the normal dental implant 200 is implanted and fixed in the alveolar bone 500, a healing abutment 600 is attached and osseointegration is awaited to complete the single-stage dental implant replacement surgery.

In summary, in the dental surgery method for single-stage dental implant replacement according to the two embodiments of the present invention, the abnormal dental implants (including abnormal dental implants 100 and 100a) are removed from the dental alveolus DA using the implant screw-out component (including implant screw-out components 1 and 1a) without severely damaging the alveolar bone 500, thereby minimizing damage to the alveolar bone 500 around the dental alveolus DA. This maintains the original condition of the dental alveolus DA, allowing a normal dental implant 200 with an interference-fit relationship with the dental alveolus DA to be re-implanted and fixed into the alveolar bone through the dental alveolus in the same dental surgery. This eliminates the need for patients to endure multiple surgeries, thereby reducing patient suffering, shortening surgery time, and reducing surgical resource consumption.

Through the detailed description of two preferred embodiments, the features and spirit of the present invention are expected to be clearly described, rather than limiting the scope of the present invention to the preferred embodiments disclosed above. On the contrary, the aim is to encompass various modifications and equivalent arrangements within the scope of the patent claims for the present invention.

What is claimed is:

1. A dental surgery method for single-stage dental implant replacement, involving removing an abnormal dental implant from a dental alveolus in an oral cavity of a patient and subsequently implanting a normal dental implant into an alveolar bone through the dental alveolus, the method comprising the steps of:
(a) mounting an implant screw-out component from an implant replacement kit onto a dental handpiece;
(b) operating the dental handpiece to drive the implant screw-out component to rotate, so that the abnormal dental implant is loosened from the alveolar bone and removed from the dental alveolus;
(c) mounting an implant screw-in component from the implant replacement kit onto the dental handpiece; and
(d) operating the dental handpiece to drive the implant screw-in component to rotate so as to interferentially implant and fix the normal dental implant through the dental alveolus into the alveolar bone, so that the normal dental implant fully occupies the dental alveolus and is fixed in the dental alveolus;
wherein there is an interference-fit relationship between the normal dental implant and the dental alveolus.

2. The dental surgery method for single-stage dental implant replacement of Claim 1, wherein the normal dental implant has an outer diameter larger than that of the abnormal dental implant by 0.2~1.5 mm, thereby establishing the interference-fit relationship between the normal dental implant and the dental alveolus.

3. The dental surgery method for single-stage dental implant replacement of Claim 1, wherein the normal dental implant has a length larger than that of the abnormal dental implant by 2~4 mm, thereby establishing the interference-fit relationship between the normal dental implant and the dental alveolus.

4. The dental surgery method for single-stage dental implant replacement of Claim 1, wherein the abnormal dental implant comprises an original engagement groove, and the step (a) comprises a step (a0), involving engaging the implant screw-out component mounted on the dental handpiece with the original engagement groove.

5. The dental surgery method for single-stage dental implant replacement of Claim 4, wherein the implant screw-out component comprises a screw-out component mounting section and a screw-out section, the screw-out component mounting section is configured to be mounted and fixed onto the dental handpiece, and the screw-out section extends from the screw-out component mounting section and has engagement threads formed on a surface thereof to interferentially engage with the original engagement groove when the implant screw-out component is driven to rotate.

6. The dental surgery method for single-stage dental implant replacement of Claim 1, wherein the normal dental implant comprises an implant engagement groove, and the step (c) comprises a step (c1), involving engaging the implant screw-in component mounted on the dental handpiece with the implant engagement groove.

7. The dental surgery method for single-stage dental implant replacement of Claim 6, wherein the implant engagement groove is a polygonal implant engagement groove, the implant screw-in component comprises a screw-in component mounting section and a screw-in section, the screw-in component mounting section is configured to be mounted and fixed onto the dental handpiece, the screw-in section extends from the screw-in component mounting section, and the screw-in section has an outer peripheral shape matching an inner peripheral shape of the implant engagement groove to engage with the implant engagement groove.

8. The dental surgery method for single-stage dental implant replacement of Claim 1, wherein the step (a) further comprises steps of:
(a1) mounting an implant cutting component from the implant replacement kit onto the dental handpiece;
(a2) operating the dental handpiece to drive the implant cutting component to rotate so as to cut a post-manufactured engagement groove on a top surface of the abnormal dental implant; and
(a3) mounting the implant screw-out component from the implant replacement kit onto the dental handpiece, and engaging the implant screw-out component with the post-manufactured engagement groove.

9. The dental surgery method for single-stage dental implant replacement of Claim 8, wherein the implant screw-out component comprises a screw-out component mounting section and a screw-out section, the screw-out component mounting section is configured to be mounted and fixed onto the dental handpiece, the screw-out section extends from the screw-out component mounting section, and the screw-out section has an outer peripheral shape matching an inner peripheral shape of the post-manufactured engagement groove to engage with the post-manufactured engagement groove.

10. The dental surgery method for single-stage dental implant replacement of Claim 8, wherein the implant cutting component comprises a cutting component mounting section and a cutting section, the cutting component mounting section is configured to be mounted and fixed onto the dental handpiece, and the cutting section extends from the cutting component mounting section to cut the post-manufactured engagement groove.
